(19) United States
(12) Patent Application Publication
(10) Pub. No.: US 2021/0148326 A1
(43) Pub. Date: May 20, 2021

(54) Tide Activated Device to Operate A Turbine Generator

(71) Applicant: Randall Thompson, JR., Lincoln, MA (US)

(72) Inventor: Randall Thompson, JR., Lincoln, MA (US)

(21) Appl. No.: 17/098,411

(22) Filed: Nov. 15, 2020

Related U.S. Application Data
(60) Provisional application No. 62/936,410, filed on Nov. 16, 2019.

(51) Int. Cl. F03B 13/26

(52) U.S. Cl. CPC F03B 13/26

(57) ABSTRACT

A tide-activated power system for deriving energy from the periodic rise and fall of the level of a body of water includes a float/weight barge for rising and falling with the level of the body of water. A hydraulic cylinder has a piston that defines a pair of variable size chambers and for forcing the working fluid as the barge rises or falls. The cylinder has an intake port and an output port associated with each of the variable size chambers. A valve associated with the output port is adapted for limiting the flow of the working fluid and, thus the movement of the piston. A flow control system directs working fluid forced from the variable size chamber that is decreasing in size as the barge rises or falls towards an energy conversion mechanism and directing working fluid from the energy conversion mechanism to the other variable size chamber.

### CROSS-REFERENCE TO RELATED APPLICATIONS

This patent application claims the benefit of provisional application 62/936,410 filed Nov. 16, 2019, which is incorporated herein by reference.

### TECHNICAL FIELD

The present invention relates to tide-activated energy generation devices and systems, and more particularly, to a tide-activated system that converts the vertical motion of a float/weight barge to a working fluid pressure to operate a turbine generator.

### BACKGROUND INFORMATION

Various apparatus and systems have attempted to generate and store power through the use of the motion of the tide or other periodic rising and falling of a body of water. One set of systems uses the horizontal flow of the wave power to rotate a generator. Another set of systems uses the vertical movement of the tide to generate power. In this second system for generating power or energy from the rise and fall of a body of water, i.e. due to the tidal range, the “vertical movement,” it is desirable to have a means for storing energy at peak periods of generation for use during periods when demand exceeds generation, i.e. at slack tide, in order that a continuous flow of energy can be provided.

One method is the use of weights that are lifted to store energy when power generation exceeds the demand and allowed to drop to generate extra power when demand exceeds the rate of power generation from the fluid level dependent system. Another method of deriving energy from the rise and fall of a body of water consists of a float adapted to move substantially in a vertical plane in response to the rise and fall of the body of water. A cylinder has a piston adapted for vertical movement relative to the cylinder in response to the rise and fall of the float with the body of water, in a manner to apply force to fluid in a chamber of the cylinder, the force being applied alternately to opposed chambers of the cylinder, means for converting force applied to the fluid to energy, and means responsive to energy demand for storing energy converted from force applied to the fluid and for converting stored energy to force applied to the fluid.

Unfortunately, there are deficiencies in traditional horizontally-oriented tide-activated power systems, including maintenance concerns due to significant seawater acting on the generator.

### BRIEF SUMMARY OF THE INVENTION

There are deficiencies in traditional horizontally-oriented tide-activated power systems. In contrast to the above-described tide-activated power systems, this tide-activated power system for deriving energy from the periodic rise and fall of the level of a body of water has a float/weight barge for rising and falling with the level of the body of water, the float/weight barge and a pair of hydraulic cylinders each having a piston defining a pair of variable size chambers for forcing the working fluid as the barge rises or falls. The system has an energy conversion mechanism for interacting with the working fluid for converting the energy from the working fluid into another form of energy. The system has a flow control system for directing working fluid forced from the variable-size chamber that is decreasing in size as the barge rises or falls towards the energy conversion mechanism and directing working fluid from the energy conversion mechanism to the variable-size chamber that is increasing in size as the barge rises or falls wherein the rise and fall of the level of the body of water results in the rise and fall of the barge therein moving the piston back and forth in each of the cylinders forcing fluid out of one side of the variable-size chamber and then the other side of the variable-size chamber as the other side is filled.

In an embodiment, the hydraulic cylinder has an intake port and an output port associated with each of the variable-size chambers. A valve is associated with the output port adapted for limiting the flow of the working fluid and thus the movement of the piston. In an embodiment, the closing of the valve therein holds the float/weight barge relative to the body of water.

In an embodiment, the energy conversion mechanism is a turbine, a hydraulic motor. The working fluid compensation system includes an accumulator for retaining the fluid from the cylinders, the turbine, a sump for holding fluid from the turbine, the turbine, the flow control system, and the variable-size chambers in the cylinders. In an embodiment, the accumulator has a weight to exert pressure on the working fluid. In another embodiment, the accumulator uses air or other gas above the working fluid to exert pressure on the working fluid; as the working fluid enters the accumulator, the gas is compressed creating potential energy to force the working fluid out at a later time.

In an embodiment, the system has a lagoon in communication with the body of water by a channel. The lagoon has a perimeter seawall enclosing the lagoon. A central seawall is positioned in the lagoon and connected to the perimeter seawall by a causeway. The central seawall is interposed between the float/weight barge and the channel between the lagoon and the body of water.

In an embodiment of a tide-activated system for deriving energy from the periodic rise and fall of the level of a body of water includes a float/weight barge for rising and falling with the level of the body of water and a pair of hydraulic cylinders. Each cylinder has a piston defining a pair of variable-size chambers for forcing a working fluid as the barge rises or falls, wherein the pistons are indirectly connected to the float/weight barge. An energy conversion mechanism of the system interacts with the working fluid for converting the energy from the working fluid into another form of energy.

In an embodiment of a tide-activated system for deriving energy from the periodic rise and fall of the level of a body of water, the system includes a flow control system for directing working fluid forced from each of the variable-size chambers that are decreasing in size as the barge rises or falls towards the energy conversion mechanism. The flow control system directs working fluid from the energy conversion mechanism to each of the variable-size chambers that are increasing in size as the barge rises or falls. The rise and fall of the level of the body of water results in the rise and fall of the barge therein moving the piston back and forth in the cylinder forcing fluid out of one side of the variable-size chamber and then the other side of the variable-size chamber as the other side is filled.

In an embodiment of a tide-activated system for deriving energy from the periodic rise and fall of the level of a body of water, each of the hydraulic cylinders is defined by a cylindrical wall and a pair of end walls. The cylinder has a single shaft extending through one of the end walls to drive the piston, therein the cross-sectional area of the variable-size chamber with the shaft is smaller than the other variable-size chamber.

In an embodiment, the pair of hydraulic cylinders are in position parallel to each other such that the shafts of each cylinder move in parallel as the barge rises or falls with the movement of the rise and fall of the body of the water.

In an embodiment, the pair of hydraulic cylinders are positioned along a longitudinal axis, wherein one of the hydraulic cylinders is above the other hydraulic cylinder relative to the float/weight barge. The single shaft extends through the bottom end wall of the upper hydraulic cylinder and through the top end wall of the lower hydraulic cylinder. The single shaft drives the piston in each of the hydraulic cylinders.

In an embodiment of the tide-activated system, a pump support shaft extends from the float/weight barge to a midpoint connection of the shaft. The shaft is in tension between the piston of one of the cylinders and the midpoint connection of the shaft, and the shaft is in compression between the piston of the other hydraulic cylinder as the barge rises or falls.

In an embodiment, a drive support mechanism is carried by the float/weight barge and has a top cap and a lower shaft interface mechanism. The pair of hydraulic cylinders are in position parallel to each other. One of the hydraulic cylinders has the shaft extending through the upper-end wall to the piston from the top cap and the other hydraulic cylinder has the shaft extending through the lower end wall to the piston from the lower shaft interface mechanism. The shafts of each cylinder move in parallel as the barge rises or falls with the movement of the rise and fall of the body of the water.

In an embodiment of a tide-activated system for deriving energy from the periodic rise and fall of the level of a body of water, the shaft of one of the cylinders is in tension as the barge rises or falls and the shaft of another cylinder is in compression as the barge rises or falls.

In an embodiment of a tide-activated system for deriving energy from the periodic rise and fall of the level of a body of water, the system includes a valve associated with the output port adapted for limiting the flow of the working fluid and thus the movement of the piston.

In an embodiment, the hydraulic cylinder has an intake port and an output port associated with each of the variable-size chambers.

In an embodiment of a tide-activated system for deriving energy from the periodic rise and fall of the level of a body of water, the energy conversion mechanism is a hydraulic motor. The system includes a working fluid compensation system including a hydraulic accumulator for retaining the fluid from the cylinders, a sump for holding fluid from the turbine, the turbine, the flow control system, and the variable-size chambers.

In an embodiment of a tide-activated system for deriving energy from the periodic rise and fall of the level of a body of water, the system includes a lagoon in communication with the body of water by a channel. The lagoon has a perimeter sea wall enclosing the lagoon and a central sea wall positioned in the lagoon and connected to the perimeter sea wall by a causeway. The central sea wall is interposed between the channel between the lagoon and the body of water and the float/weight barge.

In an embodiment of a tide-activated system for deriving energy from the periodic rise and fall of the level of a body of water, there is a plurality of float/weight barges for rising and falling with the level of the body of water. There is a pair of hydraulic cylinders associated with each of the float/weight barges. Each cylinder has a chamber with a piston defining a pair of variable-size chambers.

In an embodiment of a tide-activated system for deriving energy from the periodic rise and fall of the level of a body of water, the system includes a float/weight barge for rising and falling with the level of the body of water and a pair of hydraulic cylinders. Each of the hydraulic cylinders is defined by a cylindrical wall and a pair of end walls. Each cylinder has a piston defining a pair of variable-size chambers for forcing a working fluid as the barge rises or falls. The cylinder has a single shaft extending through one of the end walls to drive the piston. The pistons are indirectly connected to the float/weight barge and the cross-sectional area of the variable-size chamber with the shaft is smaller than the other variable-size chamber. The system has an energy conversion mechanism for interacting with the working fluid for converting the energy from the working fluid into another form of energy.

In an embodiment, the system includes a drive support mechanism carried by the float/weight barge and having a top cap and a lower shaft interface mechanism. The pair of hydraulic cylinders are in position parallel to each other. One of the hydraulic cylinders has the shaft extending through the upper-end wall to the piston from the top cap. The other hydraulic cylinder has the shaft extending through the lower end wall to the piston from the lower shaft interface mechanism such that the shafts of each cylinder move in parallel as the barge rises or falls with the movement of the rise and fall of the body of the water.

In an embodiment, the shaft of one of the cylinders is in tension as the barge rises or falls and the shaft of another cylinder is in compression as the barge rises or falls.

In an embodiment, the system has a valve associated with the output port adapted for limiting the flow of the working fluid and thus limiting the movement of the piston.

In an embodiment, the hydraulic cylinder has an intake port and an output port associated with each of the variable-size chambers.

In an embodiment of a tide-activated system for deriving energy from the periodic rise and fall of the level of a body of water, the float/weight barge is a plurality of float/weight barges. There is a pair of hydraulic cylinders for each float/weight barge.

In an embodiment of a tide-activated system for deriving energy from the periodic rise and fall of the level of a body of water, the system includes a float/weight barge for rising and falling with the level of the body of water, a drive support mechanism carried by the float/weight barge and having a top cap and a lower shaft interface mechanism, and a pair of hydraulic cylinders. Each of the hydraulic cylinders is defined by a cylindrical wall and a pair of end walls. The pair of hydraulic cylinders are in position parallel to each other. Each cylinder has a piston defining a pair of variable-size chambers for forcing the working fluid as the barge rises or falls. The cylinder has a single shaft extending through one of the end walls to drive the piston. One of the hydraulic cylinders has the shaft extending through the upper-end wall to the piston from the top cap. The other hydraulic cylinder has the shaft extending through the lower end wall to the piston from the lower shaft interface mechanism such that the shafts of each cylinder move in parallel as the barge rises or falls with the movement of the rise and fall of the body of the water. The pistons are indirectly connected to the float/weight barge. The cross-sectional area of the variable-size chamber with the shaft is smaller than the other variable-size chamber wherein the shaft of one of the cylinders is in tension as the barge rises or falls and the shaft of another cylinder is in compression as the barge rises or falls. A valve is associated with the output port adapted for limiting the flow of the working fluid and thus limiting the movement of the piston. An energy conversion mechanism interacts with the working fluid for converting the energy from the working fluid into another form of energy.

In an embodiment, there is a plurality of float/weight barges for rising and falling with the level of the body of the water and wherein there is at least a pair of hydraulic cylinders associated with each of the float/weight barges, each cylinder having a chamber with a piston defining a pair of variable size chambers.

In an embodiment, each of the hydraulic cylinders has an intake port and an output port associated with each of the variable size chambers. A valve is associated with the output port adapted for limiting the flow of the working fluid and thus the movement of the piston. In an embodiment, the closing of the valve therein holds the float/weight barge relative to the body of water.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic view of a tide-activated system including a float/weight barge;

FIG. 2 is an enlarged view of the float/weight barge and a pair of hydraulic cylinders in a high tide position of FIG. 1;

FIG. 3 is an enlarged view of the float/weight barge and a pair of hydraulic cylinders in a low tide position;

FIG. 4A is a schematic of the float/weight barge relative to the tide as the tide floods towards high tide;

FIG. 4B is a schematic of the float/weight barge relative to the tide as the tide floods towards high tide with the float/weight barge held in position by the drive pipe;

FIG. 4C is a schematic of the float/weight barge as the tide ebbs towards low tide;

FIG. 4D is a schematic of the float/weight barge as the tide approaches low tide;

FIG. 4E is a schematic of the float/weight barge relative to the tide as the tide ebbs towards low tide with the float/weight barge held in position by the drive pipe;

FIG. 4F is a schematic of the float/weight barge as the tide floods towards high tide;

FIG. 5 is a schematic of tide patterns;

FIG. 6 is a side elevation of a float/weight barge near a high tide position of an alternative tide-activated system with portions of a pair of cylinders broken away;

FIG. 7 is a side view of the plates and cylinder interface of an alternative embodiment of a tide-activated system;

FIG. 8 is a top view of an alternative mounting system for the float/weight barge of the tide-activated system;

FIG. 9 is an enlarged view of a cylinder supported by the pair of plates taken along area 9-9 in FIG. 8;

FIG. 10 is a top view of another alternative mounting system for the float/weight barge of the tide-activated system;

FIG. 11 is a schematic overview of an alternative embodiment of a tide-activated system with a plurality of float/weight barges;

FIG. 12A is a schematic of the flow control during an ebbing tide;

FIG. 12B is a schematic of the flow control during a flooding tide; and

FIG. 13 is a schematic view of an alternative embodiment of a tide activated system including a float/weight barge.

### DETAILED DESCRIPTION OF THE PREFERRED EMBODIMENTS

A tide-activated system for deriving energy from the periodic rise and fall of the level of a body of water has at least one float/weight barge and at least one pair of associated cylinders. The float/weight barge rises and falls with the level of the body of water. The pair of cylinders which are part of a hydraulic power system each have a piston defining a pair of variable size chambers. The piston forces the working fluid in one of the variable size chambers as the barge rises or falls towards the accumulator and the hydraulic motor. Each of the hydraulic cylinders has at least one port associated with each of the variable size chambers. In an embodiment, the hydraulic cylinder has a pair of ports for each of the variable size chambers; an intake port and an output port are associated with each of the variable size chambers. A valve is associated with the output port adapted for limiting the flow of the working fluid and thus the movement of the piston. The system has a hydraulic motor for interacting with the working fluid for converting the energy from the working fluid into another form of energy. The rise and fall of the level of the body of water results in the rising and falling of the barge therein moving the piston back and forth in the cylinder forcing fluid out of one side of the variable size chamber and then into the other side of the variable size chamber as the other side is filled.

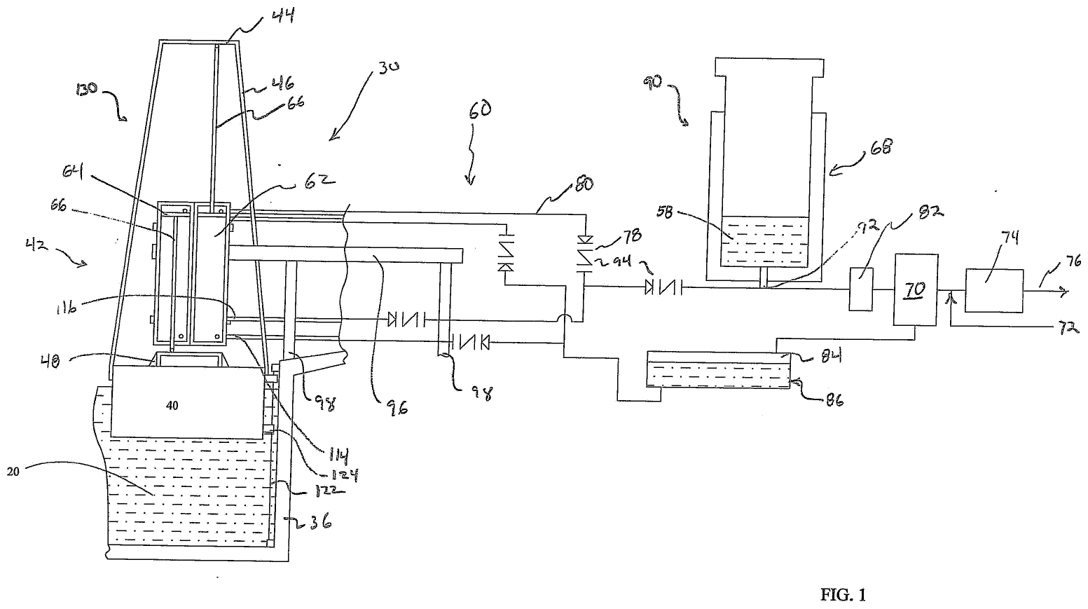

Referring to FIG. 1, a side schematic view of a portion of a tide-activated system 30 is shown. The system 30 has a float/weight barge 40 that moves upward and downward with the ebb and flood of a tidal body of water 20, such as an ocean, sea, or tidal rivers. The float/weight barge 40 has a drive support mechanism 42, including a top cap 44 and a plurality of braces 46. The system 30 has a lower shaft interface mechanism 48.

The tide-activated system 30 has a hydraulic system 60 including a pair of cylinders 62. Each of the cylinders 62 has a piston 64 that moves within the cylinder driven by a shaft 66, as described below.

The tide-activated system 30 includes the hydraulic system 60 including a working fluid 58, which is freshwater or hydraulic fluid in a preferred embodiment. The movement of the float/weigh barge 40 results in the working fluid 58 being acted upon by the hydraulic support cylinders 62 associated with the float/weigh barge 40 and in particular, the piston 64 and the shaft 66 indirectly connected to the float/weight barge 40. The working fluid 58 is transported from the hydraulic support cylinders 62 toward an accumulator 68 and a hydraulic motor 70.

The hydraulic motor 70 of the hydraulic system 60 converts the force of the working fluid 58 into rotational energy in a power shaft 72. The power shaft 72 drives an electric generator 74 that produces electrical energy as represented by arrow 76.

Interposed between the hydraulic motor 70 and the hydraulic support cylinders 62 in the direction of the flow from the hydraulic system cylinder 62 along the hydraulic piping 80 to the hydraulic motor 70 is a check valve 78 and a hydraulic governor 82. The check valve 78 prevents the working fluid 58 from flowing in the opposite direction. The hydraulic accumulator 68 is also connected with a “T” junction 92 to the hydraulic piping 80 from the hydraulic support cylinders 62 and the hydraulic motor 70.

Still referring to FIG. 1, the working fluid 58 is in a closed working fluid compensation system 90 that includes the accumulator 68 and a sump 86 of the hydraulic system 60. The sump 86 has air 84 above the working fluid 58.

As will become more evident from the descriptions below, the rate at which the working fluid 58 moves is not constant in all components. The hydraulic accumulator 68 and the sump 86 allow for the fluctuations in rates of the working fluid being forced from the cylinders 62.

The hydraulic system 60 forces the working fluid 58 towards the hydraulic motor 70 from the hydraulic support cylinder 62. During portions of the tidal period, the working fluid 58 in the system 60 is used by the electrical generator 74 to generate power via the hydraulic motor 70 as controlled by the hydraulic governor 82. Any excess working fluid 58 is forced into the accumulator 68. The accumulator 68 has a piston 88, a weight that exerts force on the working fluid 58. The upward movement of the weighted piston 88 creates potential energy. This accumulated energy is used during slack tides (high and low tide), to run the generator 74, when insufficient working fluid 58 is being pumped from the hydraulic support cylinders 62. The hydraulic governor 82 regulates the flow of the working fluid 58 to the hydraulic motor 70.

The hydraulic system 60 has a pressure valve 94 as part of the check valve 78 for those valves that allow working fluid, the hydraulic fluid, to flow away from the cylinders 62. The pressure valve 94 controls by limiting the flow from the cylinder 62 until a sufficient pressure is met. Once sufficient pressure is met, the working fluid 52 moves towards the accumulator 68 and the hydraulic motor 70.

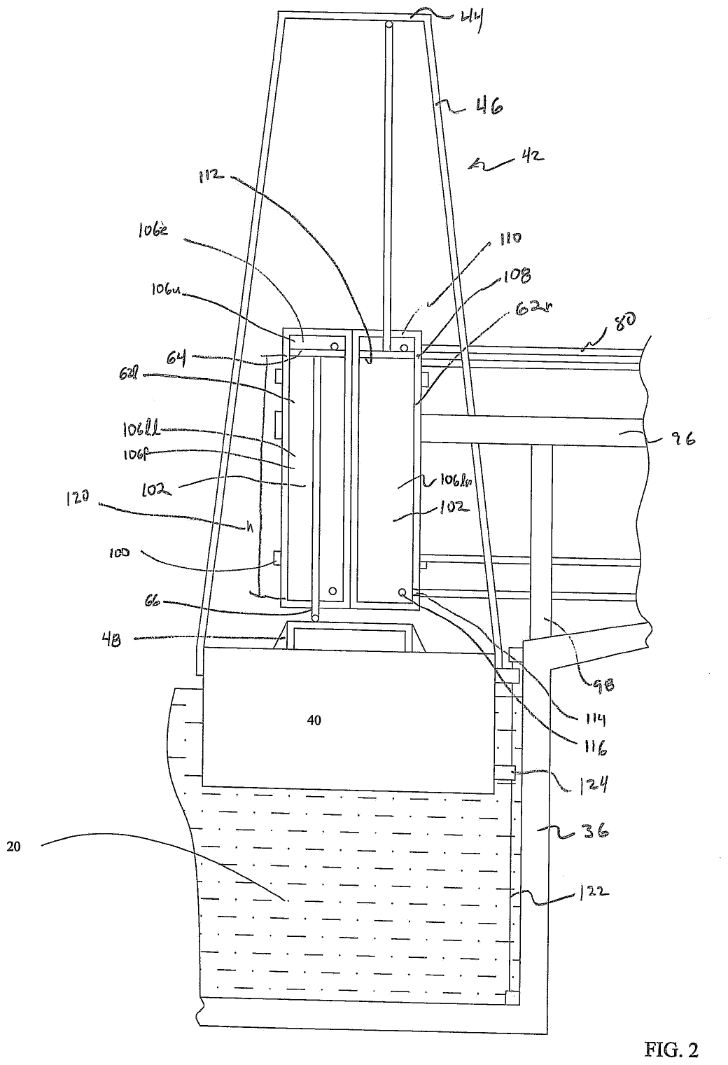

Referring to FIG. 2, an enlarged view of the float/weight barge 40 and a pair of hydraulic cylinders 62 in or near a high tide position of FIG. 1 is shown. The pair of hydraulic cylinders 62 are secured to a support beam 96 that projects from the right side of the FIG. The support beam 96 is secured to the ground by a pair of lower support beams 98, which are secured to the ground, as best seen in FIG. 1. Only one of the support beams 98 is shown in FIG. 2 In addition, a plurality of additional straps 100 secures the pair of hydraulic cylinders 62 together.

The hydraulic support cylinder 62 is shown in a sectional view in the FIG. The hydraulic support cylinder 62 defines a chamber 102 holding the piston 64. The piston 64 is moveable in the chamber 102 and defines a pair of variable size chambers 106e and 106f. Each variable size chamber 106e and 106f is defined by a cylindrical wall 108 of the hydraulic support cylinder 62, a head wall or an end wall 110 of the hydraulic support cylinder 62 and a face 112 of the piston 64. The variable size chambers 106 can be distinguished from each other in various ways: upper variable size chamber 106u and lower variable size chamber 106l and/or the variable size chamber that is being filled and increasing during size during an ebbing tide and those being filled and increasing in size during a flow or flood tide. The correlation between upper and lower and ebbing and flooding is dependent on the configuration.

Each cylinder 62 has a piston 64 and a shaft 66 which extends out of one face 112 of the piston 64 and through one of the end walls 110 of the cylinder 62. In the embodiment shown, one of the cylinders 66 has the shaft 66 extending downward and engaging with the lower shaft interface mechanism 48. The other cylinder 62 has the shaft 66 extends upward and engaging with the top cap 44. The top cap 44 is connected to the flow/weight barge 40 via a plurality of braces 46.

As seen in the FIG., each of the cylinders 62 has the chamber 102 divided by the piston 64 into a pair of the variable size chambers 106. The variable size chambers 106 vary in size as the piston 64 is moved by the shaft 66. As seen in FIG. 2, the two lower variable chambers 106l are close to their maximum size and the upper variable chambers 106u are close to their minimal size.

Each of variable size chambers 106u and 106l of each of the cylinders 62 has a pair of ports 114 and 116 for the piping 80 located on the cylinder wall 108 in proximity to the end wall 110 and is in communication with the accumulator 68, the hydraulic motor 70, and the sump 86, as seen in FIG. 1. In the embodiment shown, one of the ports 114 and 116, the outtake port 116 is for the hydraulic fluid or working fluid 58 being pushed to the accumulator 68 and the hydraulic motor 79 as the piston 64 pushes the working fluid 58 out of the variable size chamber 106. The other port, the intake port, 114 is for the working fluid 58 being drawn in from the sump 86 as the piston 64 draws the working fluid into the other variable size chamber 106. The variable size chambers 106e and 106f will be referred to at times in the specification as the ebb variable size chamber 106e and the flood variable size chamber 106f.

It is noted that that the lower variable size chamber 106l are not identical in size. The lower variable size chamber 106ll on the cylinder 62l on the left side of the FIG. has a shaft 66. The lower variable size chamber 106lr on the cylinder 62r on the right side of the FIG. does not have a shaft 66 extending through the chamber 106; the shaft 66 associated with the cylinder 62r on the right side is located in the upper variable size chamber 106ur.

As the body of water 20 rises and falls, the volume of variable size chambers is increasing or decreasing as explained below. The volume in the lower variable size chamber 106ll at a point in time is the height (h), as represented by line 120, between the face 112 of the piston 64 and the lower of the end wall 110 times radius of the cylinder (r) squared times pi (π) minus the area of the shaft which is the height (h) between the face 112 of the piston 64 and the lower of the end wall 110 times radius of the shaft (r) squared times pi (π). v=πhr_{c}²−πhrₛ²=πh(r_{c}²−rₛ²). The height (h) is varying as the shaft 66 moves up and down driven by the movement of the float/weight barge 40 in the body of water 20.

In contrast, the volume in the lower variable size chamber 106lr is the height (h) between the face 112 of the piston 64 and the lower of the end wall 110 times radius of the cylinder (r) squared times pi (Tr). v=πhr_{c}² The volume of the lower variable size chamber 106lr is large by the volume of the shaft: v=πhrₛ².

In addition to the shaft 66 and the drive support mechanism 42 limiting horizontal movements of the float/weight barge 40, the tide activated system 30 has a guidewire 122 secured to a perimeter sea wall 36. The float/weight barge 40 has a plurality of guide blocks 124 that ride up and down the guidewire 122 to limit horizontal movement of the float/weight barge 40 as the float/weight barge 40 moves vertically.

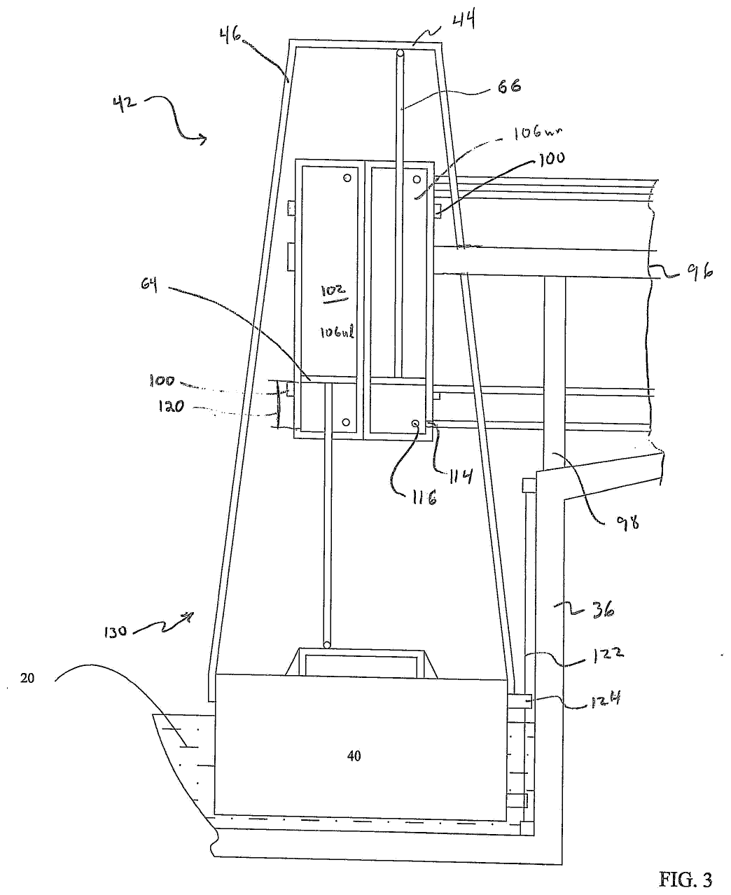

Referring to FIG. 3, an enlarged view of the float/weight barge 40 and a pair of hydraulic cylinders 62 in or near a low tide position is shown. As indicated above, the pair of hydraulic cylinders 62 are secured to a support beam 96 that projects from the right side of the FIG. In addition, the plurality of additional straps 100 secures the pair of hydraulic cylinders 62 together.

As seen in the FIG., each of the cylinders 62 has the chamber 102 divided by the piston 64 into the variable size chambers 106. The variable size chambers 106 vary in size as the piston 64 is moved by the shaft 66. As seen in FIG. 3, the two upper variable chambers 106u are close to the maximum size and the lower variable chambers 106l are close to the minimal size. It is noted that that the upper variable size chambers 106u are not identical in size. The upper variable size chamber 106ur on the cylinder 62r on the right side of the FIG. has a shaft 66. The upper variable size chamber 106ul on the cylinder 62l on the left side of the FIG. does not have a shaft 66; as indicated above with respect to FIG. 2, the shaft 66 associated with the cylinder 62l on the left side is located in the lower variable size chamber 106ll.

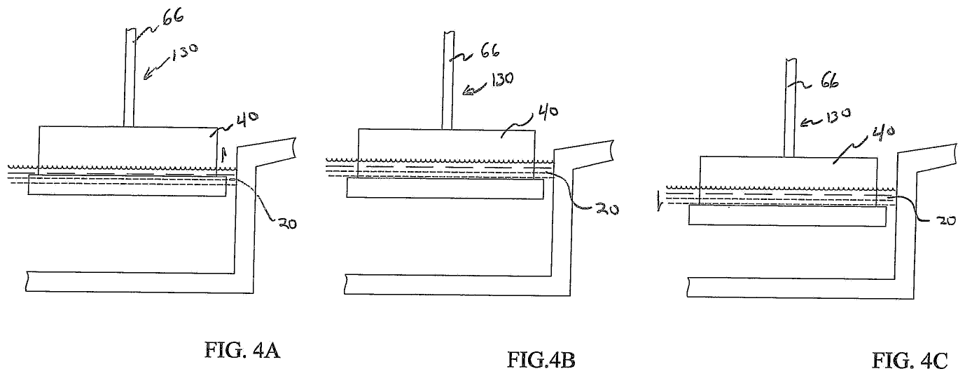

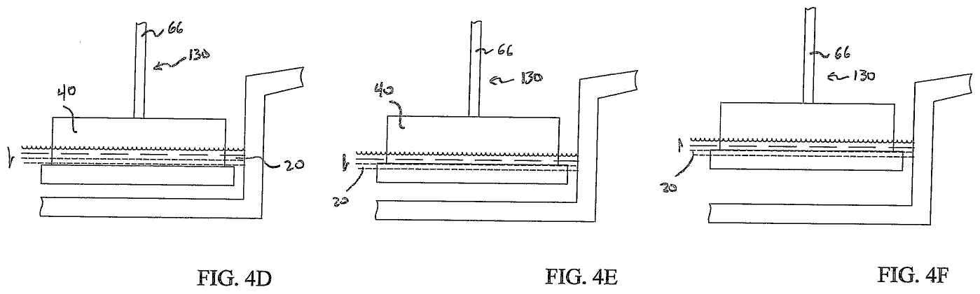

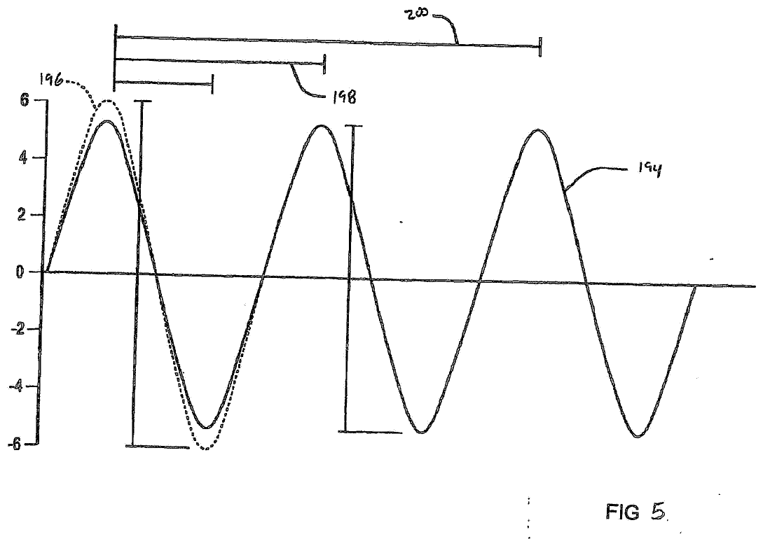

Referring to FIGS. 4A-4F, a series of schematics of the float/weight barge 40 as the tide ebbs and flow are shown. In FIG. 4A, the float/weight barge 40 is shown near high tide. As the tide continues to rise, at a certain point the pressure within the hydraulic support cylinders 62 decreases to the point that the pressure valve 94, as seen in FIG. 1, closes. The tide active system 30 has a float weight holding system 130 which include the piston 64 of each cylinder 62, the respective shafts 66 and the drive support mechanism 42 holds the float/weight barge 40 in position as the tide continues to rise; as the tide continues to flow as explained with respect to FIG. 5.

Referring to FIG. 4B, a schematic of the float/weight barge 40 is near high tide with the float/weight barge 40 held in position by the float weight holding system 130 including the piston 64 of each of the cylinders 62, the respective shaft 66 of each of the cylinders 62 of each of the cylinders 62, the respective shaft 66 of each of the cylinders 62, and the drive support mechanism 42 including the lower shaft interface mechanism 48, the braces 46, and the top cap 44. Referring to FIG. 4C, a schematic of the float/weight barge 40 as the tide drops is shown. The float/weight barge 40 moves downward as the tide ebbs towards low tide. The pressure valve 94 controls, by limiting, the flow from the cylinder 62 until a sufficient pressure is met; when sufficient pressure has been met, the working fluid 52 moves towards the accumulator 68 and the hydraulic motor 70, as seen in FIG. 1, and allow the piston 64 to move down and the float/weight barge 40 move downward with the tide.

Referring to FIG. 4D, a schematic of the float/weight barge 40 as the tide approaches low tide is shown. As the tide begins to slack near the low tide, the pressure exerted on the pressure valve 94 by the working fluid 58 and the piston 64 of the cylinders 62, as seen in FIG. 3, is reduced and the pressure valve 94 closes. Therein the float/weight barge 40 is held in position by the float weight holding system 130 including the piston 64 of each of the cylinders 62, the respective shaft 66 of each of the cylinders 62 of each of the cylinders 62, the respective shaft 66 of each of the cylinders 62, and the drive support mechanism 42 including the lower shaft interface mechanism 48, the braces 46, and the top cap 44.

Referring to FIG. 4E, a schematic of the float/weight barge 40 held in position by the float weight holding system 130 as the tide continues to drop is shown. Referring to FIG. 4F, a schematic of the float/weight barge 40 as the tide floods towards high tide is shown. The buoyancy of the float/weight barge 40 causes the float/weight barge 40 to continue moving upward as the level of the body of water 20 rises. The shaft 66 of each of cylinder 62 and the associated piston 64 and float weight holding system 130, not shown in FIG., moves upward. The shaft 66 associated with the cylinder 62r on the right side of FIG. 3, which is tied to the top cap 44, moves upward, in tension, pulling the piston 64 upward therein pushing working fluid 58 out of the upper variable size chamber 106ur of the hydraulic support cylinder 62 through the output port 116 through the pressure valve 94 as seen in FIG. 1, towards both the hydraulic accumulator 68 and the hydraulic motor 70. The working fluid 58 is drawn into the lower variable chamber 106lr, the flood variable size chamber 106f, from the sump 86 as the lower variable size chamber 106lr increases in volume as the piston 64 moves upward.

Concurrently, the shaft 66 associated with the cylinder 62I on the left side of the FIG, which is tied to the lower shaft interface mechanism 48, as shown in FIG. 2 and FIG. 3, moves upward, in compression, pushing the piston 64 upward therein pushing working fluid 58 out of the upper variable size chamber 106ul of the hydraulic support cylinder 62 through the output port 116 through the pressure valve 94 as seen in FIG. 1, towards both the hydraulic accumulator 68 and the hydraulic motor 70. The working fluid 58 is drawn into the lower variable chamber 106ll, the flood variable size chamber 106f, from the sump 86 as the lower variable size chamber 106ll increases in volume as the piston 64 moves upward.

Referring to FIG. 5, a schematic of tide patterns is shown. The ebb and flood of the tide is shown by a line 194. The term flow is also used in place of flood. The tidal range from high tide to low tide is dependent on numerous factors including location, the sun and moon location, and weather. The tidal range shown in this example is generally 10 feet. However, the tide-activated system 30 in this example is designed to accommodate a tidal range of approximately 12 feet, as represented by the dash line 196. The hydraulic support cylinder 62 stroke length and the pressure valve 94 open and closure pressure allows the drive support mechanism 42 and the float/weight barge 40 to be comparable to the movement of the tide; the movement is comparable but not identical because of the float/weight barge 40 being held by the float weight holding system 130. The amount of working fluid 58 that the tide-activated system 30 forces to the hydraulic accumulator 68 in a tidal period is dependent on the tidal range.

One example of a typical larger tidal range is a spring tide. A spring tide is the large rise and fall of the tide at or soon after the new or the full moon. The system 30, as indicated, can compensate for these fluctuations in the tide.

A tidal period 198 is the cycle of the tide, such as high tide to high tide or low tide to low tide. A tidal period lasts approximately 12 hours, 25 minutes. A tidal day 200 is 24 hours and 50 minutes in length. In a tidal day, the piston 64 in the hydraulic support cylinder 62 moves back and forth twice. The rate the piston 64 moves in the hydraulic support cylinder 62 is related to the slope of the line 194, therefore at high tide and low tide, the piston 64 will stop moving as it switches direction. At these times, no working fluid 58 is being forced into the accumulator 68 from the hydraulic support cylinder 62.

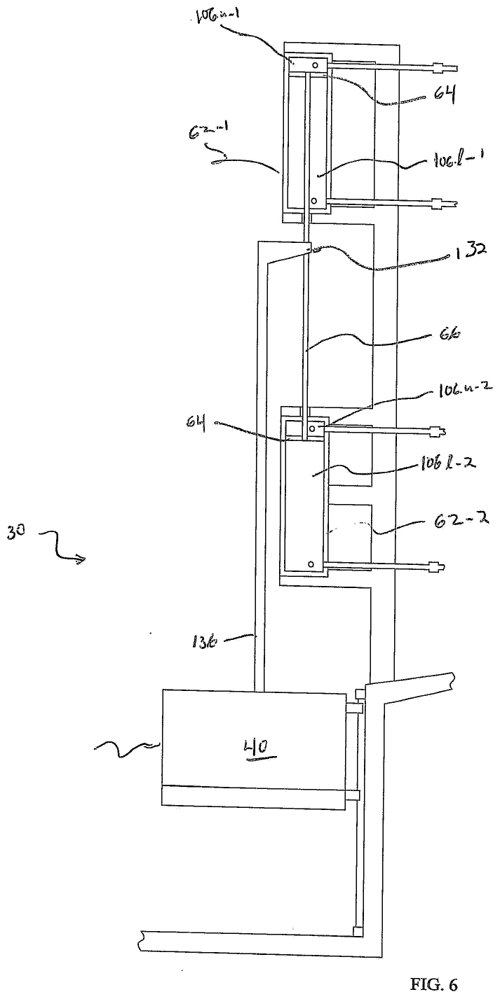

Referring to FIG. 6, a side elevation of a float/weight barge 40 near a high tide position of an alternative tide-activated system 30 with portions of a pair of cylinders 62 broken away is shown. The tide-activated system has a pump shaft support 136 extending upward from the float/weight barge 40. The pump shaft support 136 is connected to a shaft 66 at a midpoint connection 132 that extends upward to one of the cylinders 62-1 and downward to the other cylinder 62-2. The upper variable size chamber 106u-1 of the upper cylinder 62-1 and the lower variable size chamber 106l-2 of the lower cylinder 62-2 do not have the shaft 66 extending through the chamber 106 and therefore are capable of having a larger volume than the other variable size chamber 106l-1 and 106u-2.

As the pump shaft support 136 moves up and down, the shaft 66 between the midpoint connection 132 and one of the pistons 64 is in tension and the shaft 66 between the midpoint connection 132 and the other piston 64 is in compression. The transition from compression to tension or tension to compression occurs when the tide is at or near high tide and low tide.

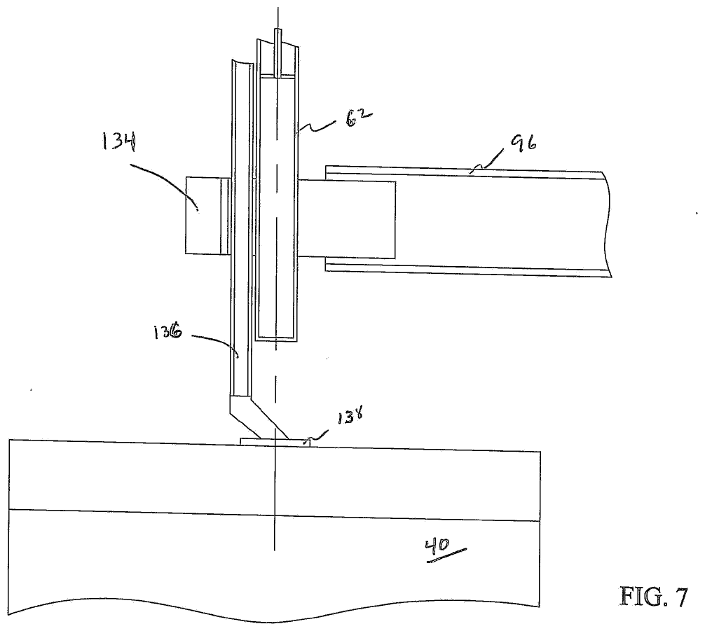

Referring to FIG. 7, a side view of plates 134 and cylinder 62 for retaining one of the cylinders 62 in an alternative embodiment is shown. The support beam 96 projects from the right side of the FIG. One of the plates 134 is shown. The cylinder 62 is interposed between the plate 134 shown behind the cylinder 62 and the other plate 134 not shown in FIG. 7.

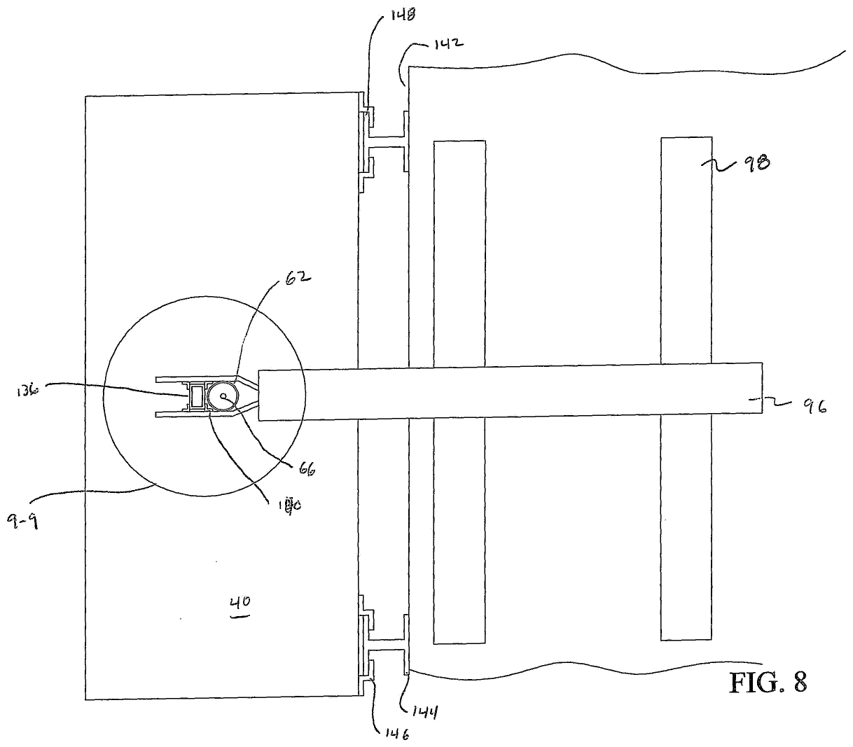

The pump shaft support 136 is secured to a mounting bracket 138. The pump shaft support 136 extends upward through the pair of plates 134 where the pump shaft support 136 is guided by a plurality of angle supports 140, as best seen in FIG. 8.

Referring to FIG. 8, a top view of the alternative mounting system for the float/weight barge 40 of the tide-activated system of FIG. 7 is shown. The float/weight barge 40 is guided as it moves up and down with the tide in part by a pair of “H” rails 144 that are secured to the wall 142. The float/weight barge 40 has a pair of angle guides 146 for each rail 144. The angle guides 146 capture the flange 148 of the “H” rail 144. While the rails and the angles are each exposed to the body of water 20, the components do not need to extend to the floor bed of the water. The system does not require interaction with the body of water beyond the depth of the float/weight barge 40 at low tide.

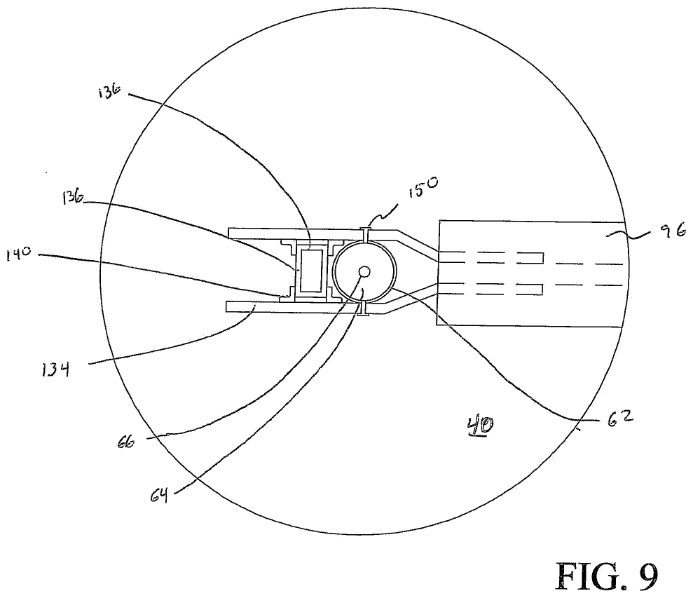

Referring to FIG. 9, an enlarged view of cylinder 62 supported by the pair of plates 134 as shown in 9-9 in FIG. 8 is shown. The cylinder 62 is supported by a pair of swivel mounts 150. The pump shaft support 136 moves relative to the pair of plates 134. The angle supports 140 are secured to the plates 134 for guiding the pump shaft support 136.

The shaft 66 is seen in the cylinder 62. As the float/weight barge 40 is shown in FIG. 7, the hydraulic system 60 has a piston 64 in the cylinder 62. When the float/weight barge 40 moves downward the piston 64 moves downward driven by the shaft 66.

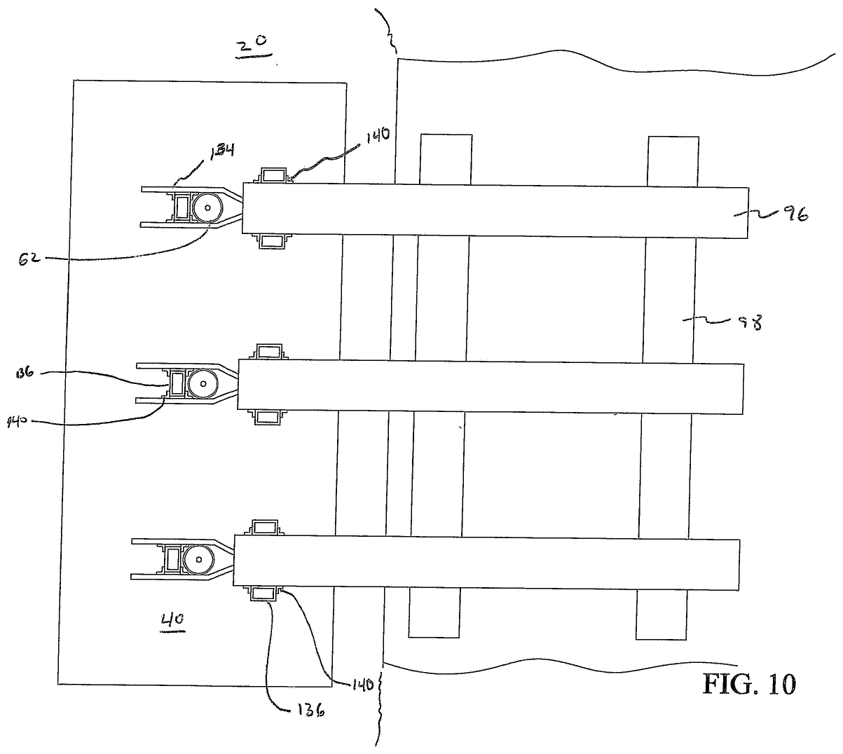

Referring to FIG. 10, a top view of another alternative mounting system for the float/weight barge 40 of the tide-activated system is shown. In contrast to the embodiments shown in FIG. 6 and FIG. 8, apart from the float/weight barge 40, no other component directly interacts with the body of water 20. The system has a pair of lower support beams 98 which are secured to the ground. In the embodiment shown, the system 30 has three support beams that are secured to the lower support beams 98 and project over the body of water 20 and a portion of the float/weight barge 40.

A pair of plates 134 are shown extending from each of the support beams 96. The pair of lower support beams 98 are shown underlying the support beam 96. Each of the support beams 96 supports a cylinder 62 which is interposed between the pair of plates 134.

In contrast to the previous embodiments, the guiding of vertical movement of the float/weight barge 40 does not have any components, with the exception of the float/weight barge 40, that interact with the body of water 20. In the embodiment shown, each float/weight barge 40 has a plurality of guide masts 136 that are secured to the float/weight barge 40 and project upward; each of the guide masts 136 is guided by angle supports 140. In the embodiments, the pair of plates 134 each have a pair of angle supports 140 such that the respective center guide mast 136 can move up and down relative to the pair of plates 134 and is guided by the angle supports 140.

In addition, each of the support beams 96 has four additional angle supports 140. The pair of outer guide masts 136 capture the support beams 96 such that the outer guide masts 136 move up and down with the float/weight barge 40.

In the embodiment shown, three cylinders 62 are shown. Each cylinder 62 are each shown supported by a pair of plates 134. It is recognized that the shaft 66 extending through one of the end walls 140 such as seen in FIG. 2, FIG. 3, and FIG. 7.

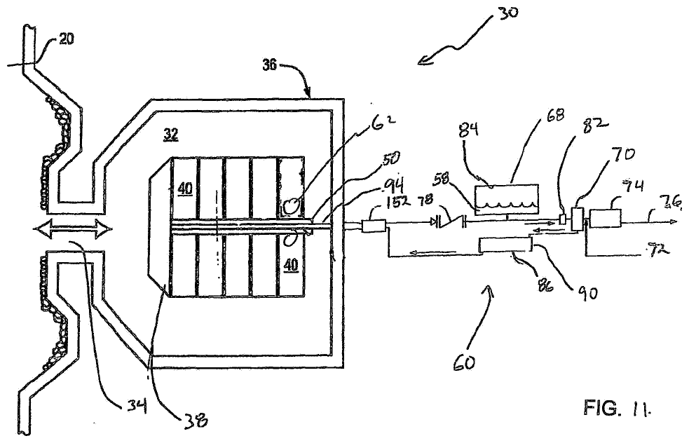

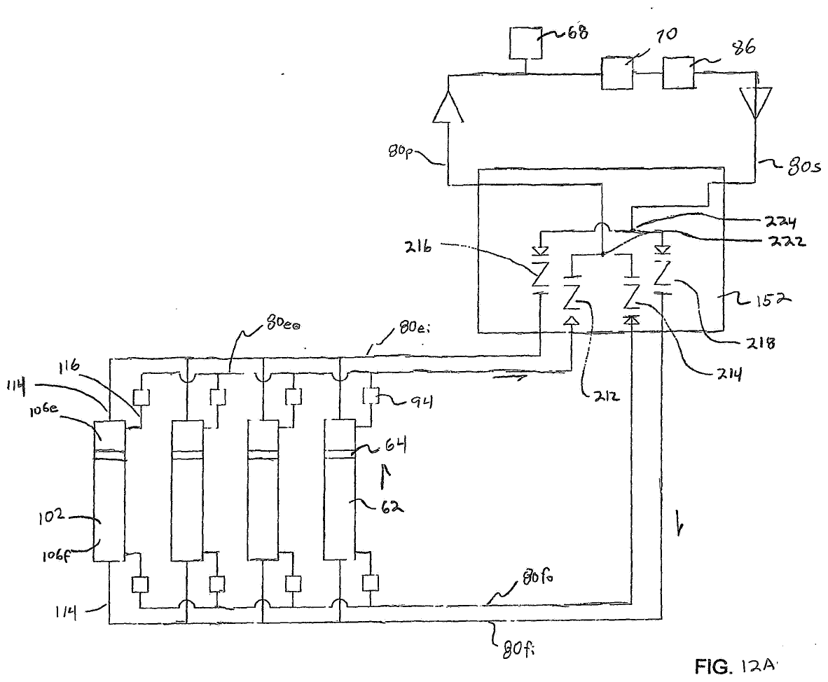

Referring to FIG. 11, a schematic overview of an alternative embodiment of the tide-activated system 30 with a plurality of float/weight barges 40 is shown. The system 30 has a lagoon 32 in communication with a tidal body of water 20 such as an ocean or sea. The lagoon 32 is positioned such that it is in communication with the tidal body of water 20 through a channel 34. The lagoon 32 has a perimeter sea wall 36 that encircles the lagoon 32. The lagoon 32 is of such a depth that there is sufficient water in the lagoon 32 even at the lowest tide so that the float/weight barge 40 does not bottom out. In addition to the perimeter sea wall 36, the system 30 has a central sea wall 38 located in the lagoon 32.

The central sea wall 38 is positioned between the channel 34 to the lagoon 32 from the body of water 20 and the plurality of float/weight barges 40. The central sea wall 38 is connected to the perimeter sea wall 36 by a causeway 50.

The majority of the horizontal component of the tide will be eliminated by the shape of the sea wall in the body of water and the channel 34 from the body of water 20 to the lagoon 32. Furthermore, the central sea wall 38, which is positioned between the channel 34 and the float/weight barges 40, reduces the horizontal component of the tide from acting on the float/weight barges 40. It is desirous to reduce, if not eliminate, any horizontal component of the wave in that it is not used to create energy in the tide-activated system 30 and furthermore can adversely affect the vertical motion of the float/weight barges 40.

Still referring to FIG. 11, in addition to the lagoon 32, the tide-activated system 30 includes a hydraulic system 60 including a working fluid 58, which is fresh water or a hydraulic fluid in a preferred embodiment, that moves from the at least one pair of hydraulic support cylinders 62 associated with each of the float/weight barges 40, and a flow control system 152. The system 60 has a hydraulic motor 70 that converts the force of the working fluid 58 into rotational energy in a power shaft 72. The power shaft 72 drives an electric generator 74 that produces electrical energy as represented by arrow 76.

Interposed between the hydraulic motor 70 and the flow control system 152 in the direction of the flow from the fluid control system 152 to the hydraulic motor 70 is a check valve 78 and a hydraulic governor 82. The check valve 78 prevents the working fluid 58 from flowing in the opposite direction. A hydraulic accumulator 68 is also connected with a “T” in the piping 80.

The hydraulic system 60 forces working fluid 58 towards the hydraulic motor 70 from the flow control system 152. During portions of the tidal period, the system 60 then can be used by the electrical generator 74 as controlled by the hydraulic governor 82. The excess working fluid 58 will then be forced into the hydraulic accumulator 68, the expansion tank. In the embodiment shown, the hydraulic accumulator 68 has air 84 above the working fluid 58. The air 84 in the expansion tank 80 is compressed by the working fluid 58 and thus accumulates energy that is used during slack tides (high and low tide), to run the generator 74, when no working fluid 58 is being pumped. The hydraulic governor 82 regulates the flow of the working fluid 58 to the hydraulic motor 70.

Still referring to FIG. 11, the system 60 has a sump 86. The working fluid 58 is in a closed working fluid compensation system 90 that includes the hydraulic accumulator 68 and the sump 86. The rate at which the working fluid 58 moves is not constant in all components. The hydraulic accumulator 68 and the sump 86 allow for the fluctuations in rates of the working fluid being forced from the cylinders 62.

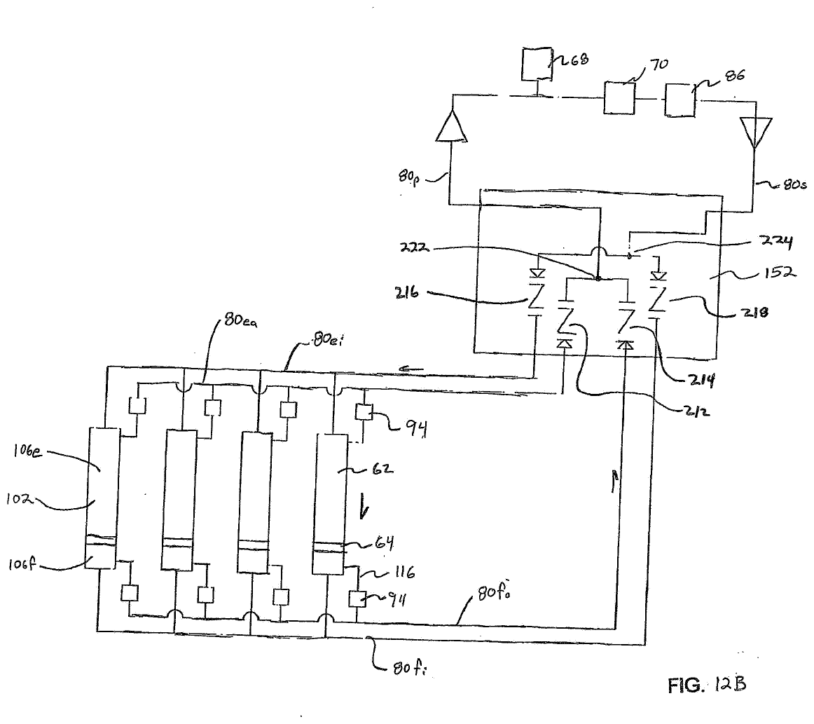

Referring to FIG. 12A, a schematic of the piping system of the tide-activated system is shown. Each hydraulic support cylinder 62 has a piston 64 that divides the chamber 102 into a flood variable size chamber 106f and an ebb variable size chamber 106e. While four hydraulic support cylinders 62 are shown in FIG. 12A, it is recognized that only two hydraulic cylinders 62 would be used in the embodiment shown in FIG. 1 if only one float/weight barge 40 is used.

The output port 116 on each of the flood variable size chamber 106f of each of the hydraulic system cylinders 62 is connected by a flood flow output piping 80fo. The output port 116 on each of the ebb variable size chambers 106e of each of the hydraulic system cylinders 62 is connected by an ebb flow output piping 80eo. A pressure valve 94 is associated with the output port 116 for each hydraulic support cylinder 62 and interposed between the output port 116 and the flow control system 152. The flood output flow piping 80fo and the ebb output flow piping 80eo are each connected to the flow control system 42.

The intake port 114 on each of the flood variable size chambers 106f of each of the hydraulic system cylinders 62 is connected by a flood intake inflow piping 80fi. The intake port 114 on each of the ebb variable size chambers 106e of each of the hydraulic system cylinders 62 is connected by an ebb intake flow piping 80ei. The flood flow inflow piping 80fi and the ebb flow inflow piping 80ei are each connected to the flow control system 152.

The working fluid 58 is routed from the flow control system 152 to the reservoir hydraulic accumulator 68 by pipe 80p. As seen in FIG. 1 and FIG. 11, the working fluid 58 is fed to the hydraulic motor 70. The working fluid 58 flows to the sump 86 from the hydraulic motor 70. The sump 86 holds the working fluid 58 for feeding to the hydraulic system cylinders 62 through the flow control system 152 via the piping 80s.

Referring back to FIG. 12A, a schematic of the flow control system 152 during an ebbing tide is shown. As the tide ebbs, the float/weight barge 40 drops resulting in the piston 64 in each of the hydraulic system cylinders 60 being forced downward by the shaft, which is either in compression or tension, as explained above, causing the working fluid 58 in the ebb variable size chamber 106e to be forced towards the flow control system 152. As indicated above, the fluid from all the ebb variable size chambers 106e are combined after the working fluid 58 goes through the respective pressure valve 94. The size of the flood variable size chambers 106f are all increasing, allowing working fluid 58 to flow to those locations from the flow control system 152. The movement of the piston 64 draws working fluid 58 into the flood variable size chambers 106f from the sump 86.

The flow control system 152 has a series of check valves 212, 214, 216, and 218 as seen in FIG. 12A to allow the working fluid 58 to move in the proper path as further explained below. All of the ebb variable size chambers 106e are connected by the intake port 114 with the piping 80ei and the output port 116 with the piping 80eo to the flow control system 152. While both pipes 80ei and 80eo contain working fluid 58, only one pipe 80e at a time will have a substantial flow. The ebb intake piping 80ei is connected to the check valve 216. The ebb output piping 80eo is connected to the check valve 212.

All of the flood variable size chambers 106f are connected by the intake port 114 with the piping 80fi and the output port 116 with the piping 80fo to the flow control system 152. While both pipes 80fi and 80fo contain working fluid 58, only one pipe 80f at a time will have a substantial flow. The flood intake piping 80fi is connected to the check valve 218. The flood output piping 80fo is connected to the check valve 214.

The piping 80p is connected to both the hydraulic accumulator 68 and the hydraulic motor 70. Both the ebb output piping 80eo and the flood output piping 80fo are connected to the hydraulic accumulator piping 80p by a tee 222. The other piping, piping 80s is connected to the sump 86. Both the ebb intake piping 80ei and the flood intake piping 80fi are connected to the sump piping 80s by a tee 224.

Still referring to FIG. 12A, as the working fluid 58 is being forced out of the ebb variable size chambers 106e by the movement of the piston 64 in each hydraulic system cylinder 60, the working fluid 58 exerts force on the check valve 212, opening the valve. The working fluid 58 is pushed to the tee 222 with a portion of the working fluid 58 reaching the hydraulic accumulator 68. The other check valve, check valve 214, associated with the tee 222 and located on the flood output piping 80fo is oriented in the opposite direction such that the force of the working fluid 58 forces the check valve 214 closed, thus the working fluid 58 cannot flow through the output pipe 80fo for the flooding side and the associated pressure valve 94.

Still referring to FIG. 12A, while the piston 64 is moving to compress and force working fluid 58 out of the ebb variable size chamber 106e, the flood variable size chamber 106f, the non-pumping chamber, is increasing in size. The increase in space allows working fluid 58 to flow from the sump 86 through the flow control system 152 to the flood variable size chamber 106f. The flow enters the flow control system 152 from the piping 80s from the sump 86. The piping 80s, similar to the piping 80p, has a tee 224 that splits into two pipes, the ebb intake piping 80ei and flood intake piping 80fi. As with the flow from the ebb variable size chamber 106e, both piping 80ei and 80fi connect to the sump 86 have working fluid 58, however only one pipe at a time will have substantial flow.

The pipe 80s, which is associated with check valve 216, and the ebb variable size chamber 106e, has no flow in that the check valve 216 is forced closed by the working fluid 58 being pushed by the piston 64 as explained above, which is greater than the force created by the pressure created by the working fluid 58 in the sump 86.

In that the flood variable size chambers 106f are increasing in size and the sump 86 is creating a force on the check valve 218, the valve is open and the working fluid 58 is allowed to flow from the sump 86 to fill the increasing size flood variable size chambers 106f.

The check valve 214, which is part of the pipe 80fo, which connects the flood variable size chamber 106f to the hydraulic accumulator 68 is held closed. The working fluid 58 that passes through the tee 222 has a larger force than that on the other side.

Referring to FIG. 12B, a schematic of the flow control 152 during a flooding tide is shown. During a flooding tide, the support mechanism 42 and the associated piston 64 are moving in the opposite direction than they were in the ebbing tide. The working fluid 58 is being forced by the piston 64 from the flood variable size chamber 106f through the flood output piping 80fo including through the pressure valve 94, the check valve 214, the tee 222, and pipe 80p to the hydraulic accumulator 68. The force of the working fluid 58 keeps the check valve 214 open and keeps the check valve 218 closed. The ebb variable size chamber 106e which was providing the working fluid 58 to the hydraulic accumulator 68 as the tide was ebbing, is now increasing in size. The working fluid 58 from the sump 86 flows through the tee 224, the ebb intake piping 80ei including check valve 216, and into the ebb variable size chamber 106e. The check valve 212 is held closed.

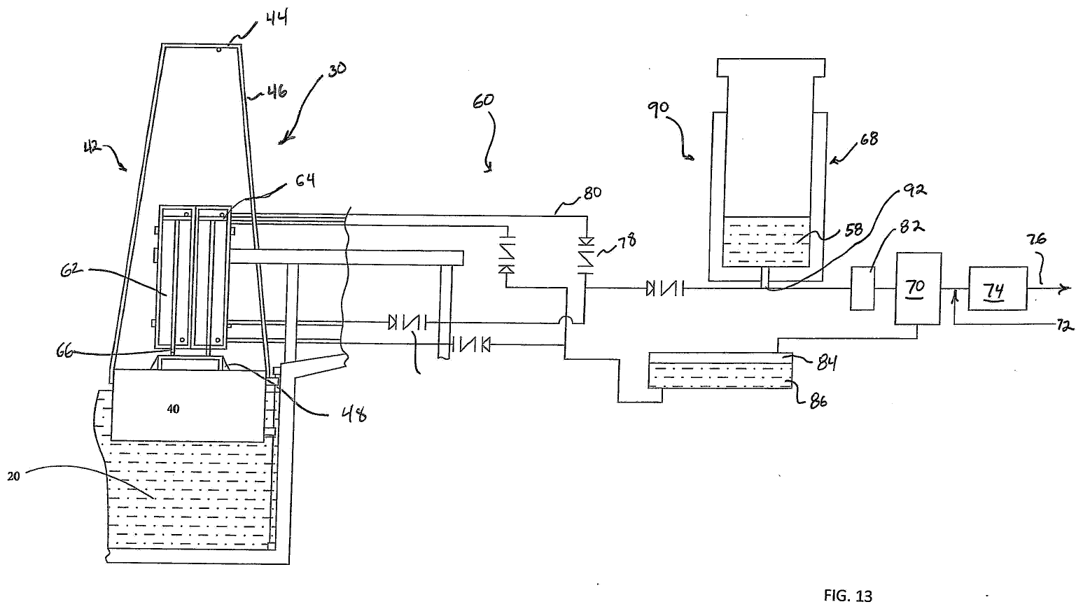

Referring to FIG. 13, a side schematic view of a portion of an alternative embodiment of the tide-activated system 30 is shown. The system 30 has a float/weight barge 40 that moves upward and downward with the ebb and flood of a tidal body of water 20 such as an ocean, sea, or tidal rivers. The float/weight barge 40 has a drive support mechanism 42 including a top cap 44 and a plurality of braces 46. The system 30 has a lower shaft interface mechanism 48.

The tide-activated system 30 has a hydraulic system 60 including a pair of cylinders 62. Each of the cylinders 62 has a piston 64 that moves within the cylinder driven by a shaft 66. In contrast to the embodiments shown in FIG. 1, the shaft 66 of each cylinder 62 extends downward. In that in both the cylinders 62 shown have the shaft 66 in the lower variable size chamber 106, the lower variable size chamber forces less working fluid 58 than the upper variable size chamber 106 for the same vertical movement. Therefore, more work fluid is moved during flooding tide than during ebbing tide. It is recognized that the accumulator 68 receives working fluid 58 during the flooding tide which is drawn upon during the ebbing tide.

The tide-activated system 30 includes the hydraulic system 60 including the working fluid 58, which is fresh water or a hydraulic fluid in a preferred embodiment. The movement of the float/weigh barge 40 results in the working fluid 58 being acted upon by the hydraulic support cylinders 62 associated with the float/weigh barge 40 and in particular the piston 64 and the shaft 66 indirectly connected to the float/weight barge 40. The working fluid 58 is transported from the hydraulic support cylinders 62 toward the accumulator 68 and the hydraulic motor 70.

The hydraulic motor 70 of the hydraulic system 60 converts the force of the working fluid 58 into rotational energy in the power shaft 72. The power shaft 72 drives the electric generator 74 that produces electrical energy as represented by arrow 76.

Interposed between the hydraulic motor 70 and the hydraulic support cylinders 62 in the direction of the flow from the hydraulic system cylinder 62 to the hydraulic motor 70 is the check valve 78 and the hydraulic governor 82 along hydraulic piping 80. The check valve 78 prevents the working fluid 58 from flowing in the opposite direction. The hydraulic accumulator 68 is also connected with the “T” junction 92 to the hydraulic piping 80 from the hydraulic support cylinders 62 and the hydraulic motor 70.

Still referring to FIG. 13, the working fluid 58 is in the closed working fluid compensation system 90 that includes the accumulator 68 and the sump 86 of the hydraulic system 60. The sump 86 has air 84 above the working fluid 58.

The invention may be embodied in other specific forms without departing from the spirit or essential characteristics thereof. The foregoing embodiments are therefore to be considered in all respects illustrative rather than limiting on the invention described herein. The true scope of the invention is thus indicated by the descriptions contained herein, as well as all changes that come within the meaning and ranges of equivalency thereof.

In one embodiment, the tide-activated system 30 has a float/weight barge 40 has a length of approximately 42 feet, a width of approximately 17 feet, and a depth or height of approximately 10 feet. The hydraulic support cylinders are a minimum of each six inches in diameter. The forces to open the pressure valve 94 is approximately equal to the force of one-foot change of height of the wave at the high and low tide.

It is recognized that the tide-activated system 30 may have additional components such as electric regulator or other methods for cleaning or smoothing the electricity from the electric generator 74.

What is claimed:

1. A tide-activated system for deriving energy from the periodic rise and fall of the level of a body of water, the system comprising:
a working fluid;
a float/weight barge for rising and falling with the level of the body of water;
a pair of hydraulic cylinders, each cylinder having a piston defining a pair of variable-size chambers for forcing the working fluid as the barge rises or falls, wherein the pistons are indirectly connected to the float/weight barge; and
an energy conversion mechanism for interacting with the working fluid for converting the energy from the working fluid into another form of energy.

2. A tide-activated system for deriving energy from the periodic rise and fall of the level of a body of water of claim 1 further comprises:
a flow control system for directing working fluid forced from each of the variable-size chambers that are decreasing in size as the barge rises or falls towards the energy conversion mechanism and directing working fluid from the energy conversion mechanism to each of the variable-size chambers that are increasing in size as the barge rises or falls wherein the rise and fall of the level of the body of water results in the rise and fall of the barge therein moving the piston back and forth in the cylinder forcing fluid out of one side of the variable-size chamber and then the other side of the variable-size chamber as the other side is filled.

3. A tide-activated system for deriving energy from the periodic rise and fall of the level of a body of water of claim 1 wherein each of the hydraulic cylinders is defined by a cylindrical wall and a pair of end walls, the cylinder having a single shaft extending through one of the end walls to drive the piston, wherein the cross-sectional area of the variable-size chamber with the shaft is smaller than the other variable-size chamber.

4. A tide-activated system for deriving energy from the periodic rise and fall of the level of a body of water of claim 3 wherein the pair of hydraulic cylinders are in position parallel to each other such that the shafts of each cylinder move in parallel as the barge rises or falls with the movement of the rise and fall of the body of the water.

5. A tide-activated system for deriving energy from the periodic rise and fall of the level of a body of water of claim 4 further comprises:
a flow control system for directing working fluid forced from each of the variable-size chambers that are decreasing in size as the barge rises or falls towards the energy conversion mechanism and directing working fluid from the energy conversion mechanism to each of the variable-size chambers that are increasing in size as the barge rises or falls wherein the rise and fall of the level of the body of water results in the rise and fall of the barge therein moving the piston back and forth in the cylinder forcing fluid out of one side of the variable-size chamber and then the other side of the variable-size chamber as the other side is filled.

6. A tide-activated system for deriving energy from the periodic rise and fall of the level of a body of water of claim 3 wherein the pair of hydraulic cylinders are positioned along a longitudinal axis, wherein one of the hydraulic cylinders is above the other hydraulic cylinder relative to the float/weight barge, the single shaft extends through the bottom end wall of the upper hydraulic cylinder and through the top end wall of the lower hydraulic cylinder, the single shaft drives the piston in each of the hydraulic cylinders.

7. A tide-activated system for deriving energy from the periodic rise and fall of the level of a body of water of claim 6 further comprises:
a flow control system for directing working fluid forced from each of the variable-size chambers that are decreasing in size as the barge rises or falls towards the energy conversion mechanism and directing working fluid from the energy conversion mechanism to each of the variable-size chambers that are increasing in size as the barge rises or falls wherein the rise and fall of the level of the body of water results in the rise and fall of the barge therein moving the piston back and forth in the cylinder forcing fluid out of one side of the variable-size chamber and then the other side of the variable-size chamber as the other side is filled.

8. A tide-activated system for deriving energy from the periodic rise and fall of the level of a body of water of claim 7 further comprising a pump support shaft that extends from the float/weight barge to a midpoint connection of the shaft wherein the shaft is in tension between the piston of one of the cylinders and the midpoint connection of the shaft and the shaft is in compression between the piston of the other hydraulic cylinder as the barge rises or falls.

9. A tide-activated system for deriving energy from the periodic rise and fall of the level of a body of water of claim 3 further comprising a drive support mechanism carried by the float/weight barge and having a top cap and a lower shaft interface mechanism wherein the pair of hydraulic cylinders are in position parallel to each other, one of the hydraulic cylinders having the shaft extending through the upper end wall to the piston from the top cap and the other hydraulic cylinder having the shaft extending through the lower end wall to the piston from the lower shaft interface mechanism such that the shafts of each cylinder move in parallel as the barge rises or falls with the movement of the rise and fall of the body of the water.

10. A tide-activated system for deriving energy from the periodic rise and fall of the level of a body of water of claim 9 further comprises:
a flow control system for directing working fluid forced from each of the variable-size chambers that are decreasing in size as the barge rises or falls towards the energy conversion mechanism and directing working fluid from the energy conversion mechanism to each of the variable-size chambers that are increasing in size as the barge rises or falls wherein the rise and fall of the level of the body of water results in the rise and fall of the barge therein moving the piston back and forth in the cylinder forcing fluid out of one side of the variable-size chamber and then the other side of the variable-size chamber as the other side is filled.

11. A tide-activated system for deriving energy from the periodic rise and fall of the level of a body of water of claim 10 wherein the shaft of one of the cylinders is in tension as the barge rises or falls and the shaft of another cylinder is in compression as the barge rises or falls.

12. A tide-activated system for deriving energy from the periodic rise and fall of the level of a body of water of claim 1 further comprises a valve associated with the output port adapted for limiting the flow of the working fluid and thus the movement of the piston.

13. A tide-activated system for deriving energy from the periodic rise and fall of the level of a body of water of claim 12 wherein the hydraulic cylinder has an intake port and an output port associated with each of the variable-size chambers.

14. A tide-activated system for deriving energy from the periodic rise and fall of the level of a body of water of claim 1 wherein the energy conversion mechanism is a hydraulic motor, and the system further comprises a working fluid compensation system including:
a hydraulic accumulator for retaining the fluid from the cylinders;
a sump for holding fluid from the turbine; and
the turbine, the flow control system, and the variable-size chambers.

15. A tide-activated system for deriving energy from the periodic rise and fall of the level of a body of water of claim 1 further comprising:
a lagoon in communication with the body of water by a channel, the lagoon having a perimeter sea wall enclosing the lagoon and a central sea wall positioned in the lagoon and connected to the perimeter sea wall by a causeway, wherein the central sea wall is interposed between the channel between the lagoon and the body of water and the float/weight barge.

16. A tide-activated system for deriving energy from the periodic rise and fall of the level of a body of water of claim 1 wherein there is a plurality of float/weight barges for rising and falling with the level of the body of water and wherein there is a pair of hydraulic cylinders associated with each of the float/weight barges, each cylinder having a chamber with a piston defining a pair of variable-size chambers.

17. A tide-activated system for deriving energy from the periodic rise and fall of the level of a body of water, the system comprising:
a working fluid;
a float/weight barge for rising and falling with the level of the body of water;
a pair of hydraulic cylinders, each of the hydraulic cylinders is defined by a cylindrical wall and a pair of end walls, each cylinder has a piston defining a pair of variable-size chambers for forcing the working fluid as the barge rises or falls, the cylinder has a single shaft extending through one of the end walls to drive the piston, wherein the pistons are indirectly connected to the float/weight barge, and the cross-sectional area of variable-size chamber with the shaft is smaller than the other variable-size chamber; and
an energy conversion mechanism for interacting with the working fluid for converting the energy from the working fluid into another form of energy.

18. A tide-activated system for deriving energy from the periodic rise and fall of the level of a body of water of claim 17 further comprising a drive support mechanism carried by the float/weight barge and having a top cap and a lower shaft interface mechanism wherein the pair of hydraulic cylinders are in position parallel to each other, one of the hydraulic cylinders having the shaft extending through the upper end wall to the piston from the top cap and the other hydraulic cylinder having the shaft extending through the lower end wall to the piston from the lower shaft interface mechanism such that the shafts of each cylinder move in parallel as the barge rises or falls with the movement of the rise and fall of the body of the water.

19. A tide-activated system for deriving energy from the periodic rise and fall of the level of a body of water of claim 18 further comprises:
a flow control system for directing working fluid forced from each of the variable-size chambers that are decreasing in size as the barge rises or falls towards the energy conversion mechanism and directing working fluid from the energy conversion mechanism to each of the variable-size chambers that are increasing in size as the barge rises or falls wherein the rise and fall of the level of the body of water results in the rise and fall of the barge therein moving the piston back and forth in the cylinder forcing fluid out of one side of the variable-size chamber and then the other side of the variable-size chamber as the other side is filled.

20. A tide-activated system for deriving energy from the periodic rise and fall of the level of a body of water of claim 19 wherein the shaft of one of the cylinders is in tension as the barge rises or falls and the shaft of another cylinder is in compression as the barge rises or falls.

21. A tide-activated system for deriving energy from the periodic rise and fall of the level of a body of water of claim 20 further comprises a valve associated with the output port adapted for limiting the flow of the working fluid and thus limiting the movement of the piston.

22. A tide-activated system for deriving energy from the periodic rise and fall of the level of a body of water of claim 21 wherein hydraulic cylinder has an intake port and an output port associated with each of the variable-size chambers.

23. A tide-activated system for deriving energy from the periodic rise and fall of the level of a body of water of claim 20 wherein the energy conversion mechanism is a hydraulic motor, and the system further comprises a working fluid compensation system including:
a hydraulic accumulator for retaining the fluid from the cylinders;
a sump for holding fluid from the turbine; and
the turbine, the flow control system, and the variable-size chambers.

24. A tide-activated system for deriving energy from the periodic rise and fall of the level of a body of water of claim 20 wherein the float/weight barge is a plurality of float/weight barges, and there is a pair of hydraulic cylinders for each float/weight barge.

25. A tide-activated system for deriving energy from the periodic rise and fall of the level of a body of water, the system comprising:
a working fluid;
a float/weight barge for rising and falling with the level of the body of water;
a drive support mechanism carried by the float/weight barge and having a top cap and a lower shaft interface mechanism;
a pair of hydraulic cylinders, each of the hydraulic cylinders is defined by a cylindrical wall and a pair of end walls, the pair of hydraulic cylinders are in position parallel to each other, each cylinder has a piston defining a pair of variable-size chambers for forcing the working fluid as the barge rises or falls, the cylinder has a single shaft extending through one of the end walls to drive the piston, one of the hydraulic cylinders having the shaft extending through the upper end wall to the piston from the top cap and the other hydraulic cylinder having the shaft extending through the lower end wall to the piston from the lower shaft interface mechanism such that the shafts of each cylinder move in parallel as the barge rises or falls with the movement of the rise and fall of the body of the water wherein the pistons are indirectly connected to the float/weight barge and the cross-sectional area of the variable-size chamber with the shaft is smaller than the other variable-size chamber wherein the shaft of one of the cylinders is in tension as the barge rises or falls and the shaft of another cylinder is in compression as the barge rises or falls;
a valve associated with the output port adapted for limiting the flow of the working fluid and thus limiting the movement of the piston; and
an energy conversion mechanism for interacting with the working fluid for converting the energy from the working fluid into another form of energy.
